(19) United States
(12) Patent Application Publication
(10) Pub. No.: US 2026/0053102 A1
(43) Pub. Date: Feb. 26, 2026

(54) SELF-CLEANING FLOW CONTROL VALVE

(71) Applicant: K-Rain Manufacturing Corp., Riviera Beach, FL (US)

(72) Inventors: Trevor P. Kah, North Palm Beach, FL (US); Carl L.C. Kah, III, North Palm Beach, FL (US); Danhui Luo, Lake Worth, FL (US); Andrew Bloomfield, West Palm Beach, FL (US)

(21) Appl. No.: 19/304,850

(22) Filed: Aug. 20, 2025

Related U.S. Application Data
(60) Provisional application No. 63/685,793, filed on Aug. 22, 2024.

(51) Int. Cl. A01G 25/16; F16K 7/07

(52) U.S. Cl. CPC A01G 25/165; F16K 7/07

(57) ABSTRACT

A flow control valve for an irrigation system includes a planar filter screen upstream of an inlet to a metering passage and a scraper device mounted to automatically clean the screen when water is flowing into the metering passage.

### CROSS-REFERENCE TO RELATED APPLICATIONS

The present application claims benefit of and priority to U.S. Provisional Patent Application Ser. No. 63/685,793, filed Aug. 22, 2024, entitled SELF-CLEANING FLOW CONTROL VALVE, the entire content of which is hereby incorporated by reference herein.

### BACKGROUND

### Field

The present application relates to a flow control valve used in an irrigation system. Flow control valves are commonly used in irrigation systems to control flow of water through a pipe or pipes. In general, such flow control valves are controlled from a remote irrigation controller that sends signals to open and close the valve. In general, the control signals may be used to activate a solenoid that opens and closes the valve.

In conventional valves, a closure element is provided with a sealing surface that may be moved toward and away from a valve seat to selectively open and close the valve. One type of such a valve utilizes a flexible diaphragm to move the sealing surface toward and away from the valve seat such that when the sealing surface is in contact with the seat, the upper portion of the valve is closed off. The diaphragm structure includes a metering passage that allows water to enter the upper portion of the valve through the diaphragm in a measured fashion to build and maintain pressure to hold the valve closed. In such valves, the metering passage is narrow with a limited flow area provided to allow water to flow into the upper portion. Accordingly, a common problem in such valves is debris, which may be included in the flow of water, clogging the metering passage or an inlet or outlet thereof. Clogging of the metering passage prevents proper operation of the valve. In particular, clogging of the metering passage prevents the flow of water to the upper portion of the valve such that pressure in the upper portion becomes too low to keep the seal in place and the valve winds up being stuck in the open position.

Accordingly, it is an object of the present disclosure to provide a flow control valve in an irrigation system that avoids these and other problems.

### SUMMARY

A flow control valve in accordance with an embodiment of the present disclosure includes a planar filter screen to prevent debris from entering the valve and a cleaning element to remove debris from the screen.

A flow control valve in accordance with an embodiment of the present disclosure includes: a valve seat in fluid communication with a water supply; a base configured to selectively contact the valve seat to seal the valve seat; a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat; a top portion provided above the flexible diaphragm; an inlet ring formed in the base and including at least one opening configured to allow water to flow therethrough and into the top portion, wherein water pressure above the diaphragm portion holds the base on the valve seat; a metering passage provided downstream of the inlet ring and in fluid communication therewith to allow water into the top portion; a metering pin adjustably mounted in the metering passage such that a position of the metering pin controls an amount of water that passes through the metering passage and into the top portion; a planar filter provided upstream of the inlet ring and positioned such that water flows through the planar filter and into the inlet ring wherein the planar filter prevents debris from entering the inlet ring; a planar scraper positioned upstream parallel to the planar filter and rotatably mounted on the planar filter such that the planar scraper rotates as water flows through it and into the planar filter, wherein the planar scraper removes debris from the planar filter as it rotates.

In embodiments, the base includes a seal portion provided on a bottom surface of the base and configured to provide a seal between the base and the valve seat.

In embodiments, the flow control valve includes a securing element configured to connect to the inlet ring such that the diaphragm portion and based are held in place between the securing element and the inlet ring.

In embodiments, the securing element includes at least one thread that is configured to engage at least one corresponding thread of the inlet ring such that the diaphragm portion is secured in place between the inlet ring and based and the securing portion.

In embodiments, the inlet ring includes a plurality of openings to allow water flow through the inlet ring.

In embodiments, the planar scraper is disk shaped and includes one or more openings through which water passes into the planar filter.

In embodiments, the planar scraper includes at least one ridge extending upward from a top surface and facing the planar filter, wherein the at least one ridge contacts the planar filter when water is flowing and the scraper is rotating relative to the planar filter to remove debris from the planar filter.

In embodiments, the planar scraper includes at least one impeller blade extending from a bottom surface thereof such that the flow of water rotates the planar scraper.

In embodiments, the planar scraper includes a plurality of impeller blades extending from a bottom surface thereof such that the flow of water rotates the planar scraper.

In embodiments, the planar scraper includes a disk shaped body, wherein the body includes a plurality of openings formed therethrough, wherein water flows through the openings and into the planar filter and valve.

In embodiments, the planar scraper includes a plurality of ridges extending from the top surface of the planar scraper to contact the planar filter when the planar scraper rotates.

In embodiments, the planar scraper includes a plurality of curved fins formed around a periphery of a bottom surface thereof such that the flow of water rotates the planar scraper.

In embodiments, the planar scraper includes a base element rotatably connecting the planar scraper to the planar filter such that the scraper is rotatable relative to the base element and the planar filter.

In embodiments, the base element includes a cylindrical central shaft with a square end that is received in the planar filter to prevent the base element from rotating relative to the planar filter.

In embodiments, the base element includes a coil spring mounted on the central shaft to limit rotation of the planar scraper relative to the planar filter and the base element.

In embodiments, one leg of the coil spring is in contact with a straight wall positioned inside the periphery of the lower surface of the planar scraper and a second leg is in contact with a wall extending upward from a top surface of a lower portion of the base element to bias the scraper into a first position.

In embodiments, the top surface of the lower portion of the base element includes a cylindrical peg extending upward toward the planar filter and spaced from the wall to limit rotation of the planar scraper relative to the base element and the planar filter.

A flow control valve for an irrigation system in accordance with another embodiment of the present disclosure includes: a valve seat in fluid communication with a water supply; a base configured to selectively contact the valve seat to seal the valve seat; a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat; a top portion provided above the flexible diaphragm; an inlet ring formed in the base and including at least one opening configured to allow water to flow therethrough and into the top portion, wherein water pressure above the diaphragm portion holds the base on the valve seat; a metering passage provided downstream of the inlet ring and in fluid communication therewith to allow water into the top portion; a metering pin adjustably mounted in the metering passage such that a position of the metering pin controls an amount of water that passes through the metering passage and into the top portion; a planar filter provided upstream of the inlet ring and positioned such that water flows through the planar filter and into the inlet ring wherein the planar filter prevents debris from entering the inlet ring; a planar scraper positioned upstream and parallel to the planar filter and rotatably mounted on the planar filter such that the scraper rotates as water flows through it and into the planar filter, wherein the planar scraper includes at least one impeller blade extending from an upstream side thereof such that the flow of water rotates the planar scraper and removes debris from the planar filter.

In embodiments, the planar scraper includes a plurality of impeller blades, wherein the plurality of impeller blades rotate the planar scraper when water flows.

In embodiments, the planar scraper includes a disk shaped body, wherein the body includes a plurality of openings formed therethrough, wherein water flows through the openings and into the planar filter and valve.

In embodiments, the planar scraper includes one or more ridges extending from the downstream side of the planar scraper to contact the planar filter when the planar scraper rotates.

A flow control valve for an irrigation system in accordance with another embodiment of the present disclosure includes: a valve seat in fluid communication with a water supply; a base configured to selectively contact the valve seat to seal the valve seat; a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat; a top portion provided above the flexible diaphragm; an inlet ring formed in the base and including at least one opening configured to allow water to flow therethrough and into the top portion, wherein water pressure above the diaphragm portion holds the base on the valve seat; a metering passage provided downstream of the inlet ring and in fluid communication therewith to allow water into the top portion; a metering pin adjustably mounted in the metering passage such that a position of the metering pin controls an amount of water that passes through the metering passage and into the top portion; a planar filter provided upstream of the inlet ring and positioned such that water flows through the planar filter and into the inlet ring wherein the planar filter prevents debris from entering the inlet ring; a planar scraper positioned upstream of the planar filter and including a plurality of curved fins positioned around a periphery of a bottom surface of the planar scraper element such that the planar scraper rotates as water flows through it and into the planar filter to remove debris from the planar filter.

In embodiments, the flow control valve includes a base element rotatably connecting the planar scraper to the planar filter such that the planar scraper is rotatable relative to the base element and the planar filter.

In embodiments, the base element includes a cylindrical central shaft with a square end that is received in the planar filter to prevent the base element from rotating relative to the planar filter.

In embodiments, the base element includes a coil spring mounted on the central shaft and in contact with the planar scraper to limit rotation of the planar scraper relative to the planar filter and the base element.

In embodiments, one leg of the coil spring is in contact with a straight wall extending inside the periphery of the bottom surface of the planar scraper and a second leg in contact with a wall extending upward from a top surface of a lower portion of the base element to bias the planar scraper into a first position such that the planar scraper returns to the first position when water stops flowing through the planar filter.

In embodiments, the top surface of the lower portion of the base element includes a cylindrical peg extending upward toward the planar filter and spaced from the wall to limit rotation of the planar scraper relative to the base element and the planar filter.

### BRIEF DESCRIPTION OF THE DRAWINGS

FIG. 1 illustrates a bottom perspective view of a diaphragm portion of a flow control valve in accordant with an embodiment of the present disclosure;

FIG. 2 illustrates a bottom view of the diaphragm portion of the flow control valve of FIG. 1 in accordance with an embodiment of the present disclosure;

FIG. 3 illustrates a cross-sectional view of the diaphragm portion of the flow control valve of FIG. 1 in accordance with an embodiment of the present disclosure;

FIG. 4 illustrates a flow control valve including the diaphragm portion of FIG. 1 in accordance with an embodiment of the present disclosure;

FIG. 5 illustrates a top view of a planar scraper suitable for use in the flow control valve of FIG. 1;

FIG. 6 illustrates a bottom perspective view of a diaphragm portion of a flow control valve in accordant with another embodiment of the present disclosure;

FIG. 7 illustrates a top view of a planar scraper suitable for use in the flow control valve of FIG. 6;

FIG. 8 illustrates a bottom perspective view of a diaphragm portion of a flow control valve in accordant with another embodiment of the present disclosure;

FIG. 9 illustrates a top view of a planar scraper suitable for use in the flow control valve of FIG. 8;

FIG. 10 illustrates a cross-sectional view of a diaphragm portion of a flow control valve in accordance with an embodiment of the present disclosure;

FIG. 11 illustrates a bottom perspective view of a base element used to rotatably secure a scraper on a planar filter of the diaphragm portion of FIG. 10;

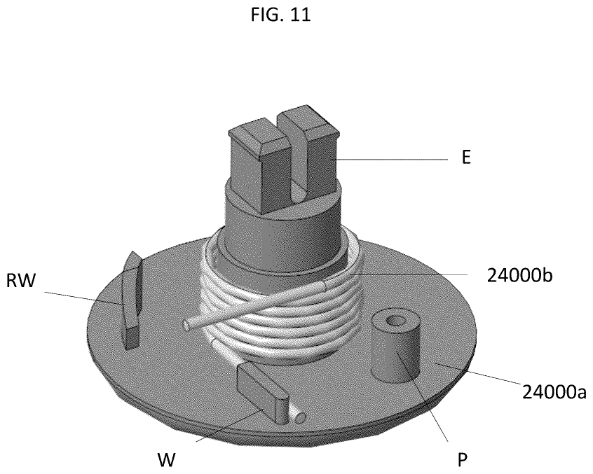

FIG. 12 illustrates a bottom perspective view of the scraper of the diaphragm portion of the flow control valve of FIG. 10; and

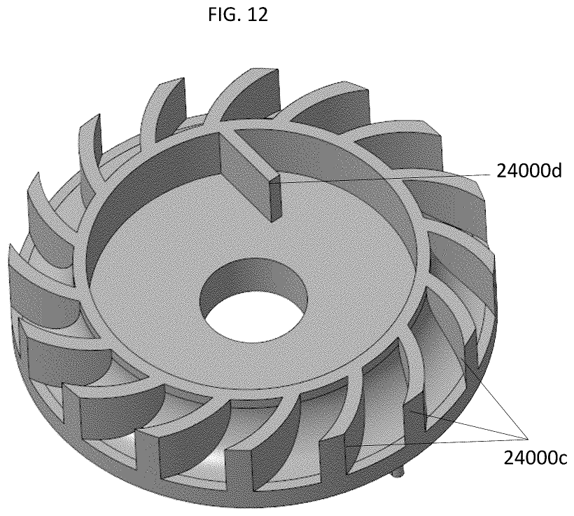

FIG. 13 illustrates a top perspective view of the scraper of the diaphragm portion of the flow control valve of FIG. 10.

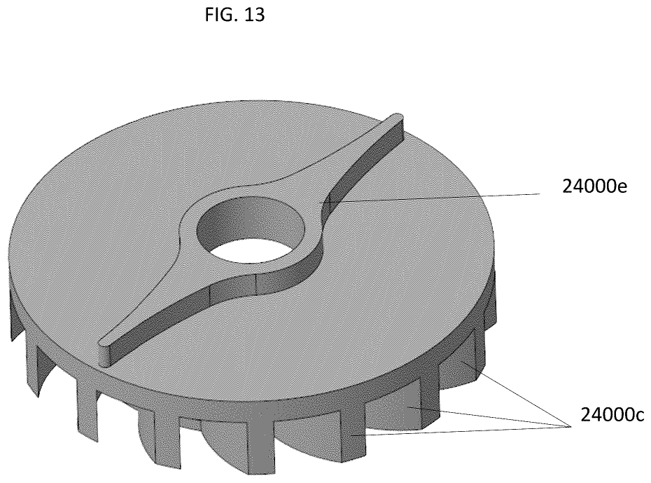

### DESCRIPTION OF THE EMBODIMENTS

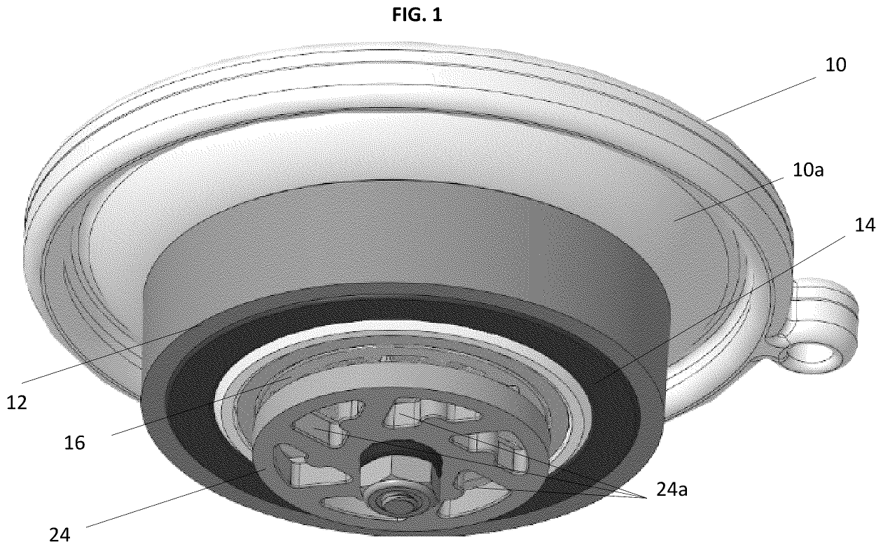

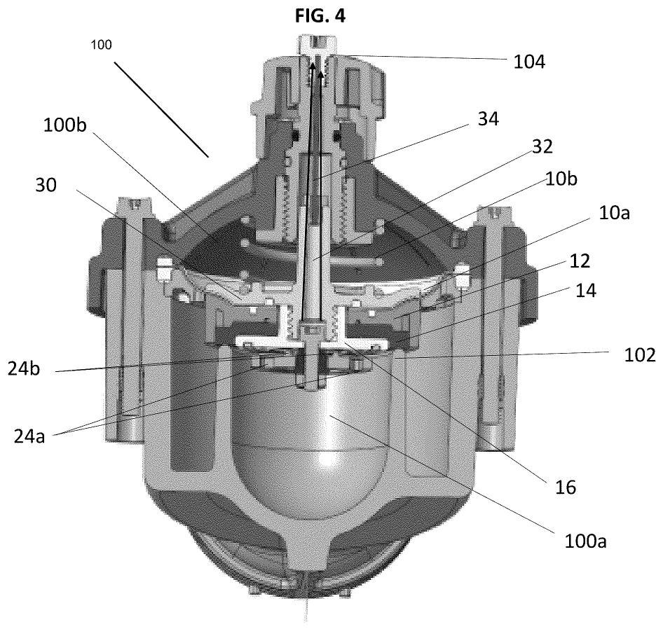

FIG. 1 illustrates a diaphragm portion 10 of a flow control valve 100 (see FIG. 4, for example) for use in an irrigation system. In embodiments, the diaphragm portion 10 includes a flexible diaphragm element 10a with base element 12 provided at a center thereof. In embodiments, an integral sealing surface 14 may be integrated into the base element 12 and may be made of a resilient material. In embodiments, an inlet ring 16 may be provided at a center of the base element 12 and includes a plurality of openings 16a through which water passes through the diaphragm element 10a as well as the base element 12.

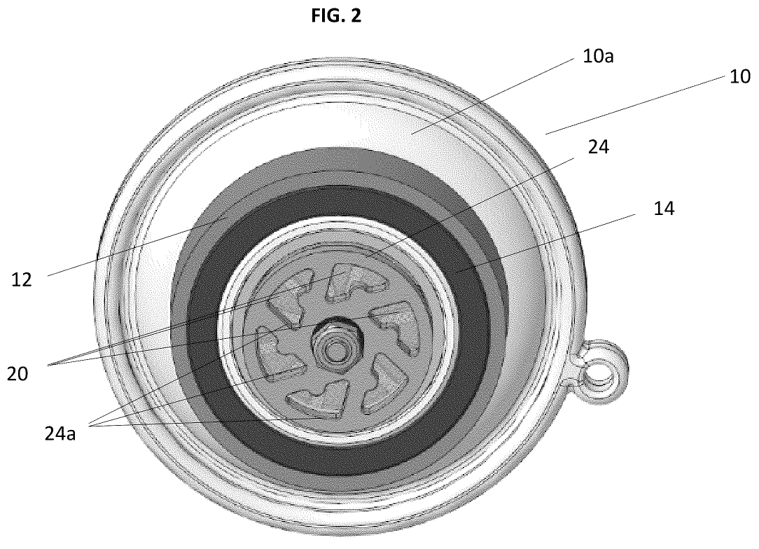

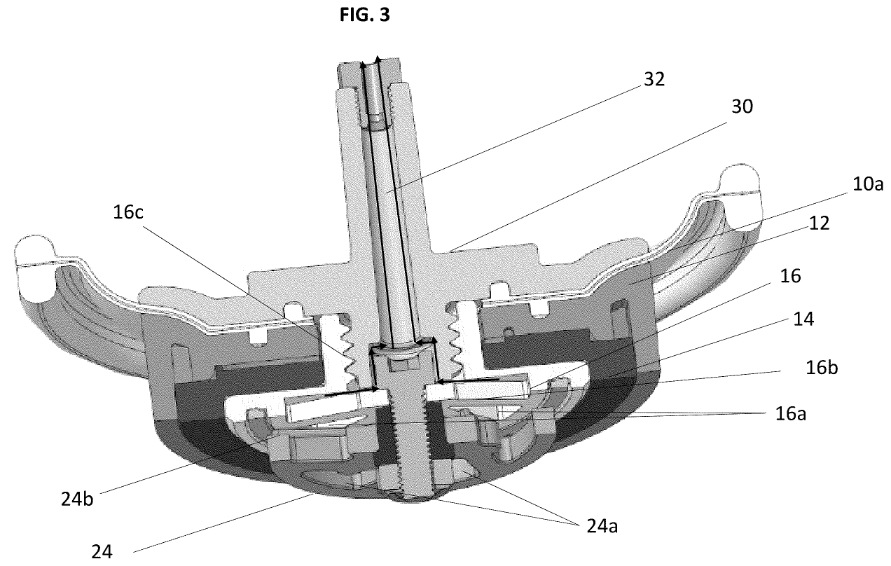

In embodiments, a planar filter screen 20 (see FIG. 2) may be provided upstream of the inlet ring 16 and covering the ring such that water must pass through the screen to enter the inlet ring 16. In embodiments, the planar filter screen 20 is substantially circular in shape and is configured to prevent debris that may be in the water passing through the pipe, for example, from entering the inlet ring 16. In embodiments, the openings in the planar filter screen 20 are sized to prevent debris from entering the inlet ring 16 to prevent clogging of the metering passage 32 (see FIG. 3, for example) discussed further below.

In embodiments, a scraper 24 is rotatably mounted upstream and parallel to the planar filter screen 20. In embodiments, the scraper 24 has a circular base that overlaps the screen 20 and is positioned parallel to the screen. In embodiments, the scraper 24 includes a plurality of openings 24a through which water passes into and through the screen 20 and into inlet ring 16. In embodiments, when water is not flowing, the scraper 24, including ridges 24b formed on a top surface thereof facing the planar filter screen 20, are spaced from the screen. In embodiments, when water begins to flow, water pressure pushes the scraper 24 toward the planar screen 20 such that the ridges 24b contact the screen 20. In embodiments, the flow of water through the openings 24a and against the ridges 24b imparts a twisting force on the scraper 24 such that the planar scraper 24 begins to rotate relative to the planar filter screen 20. In embodiments, the top surface of the scraper 24 which faces the screen 20 includes one or more ridges 24b that selectively contact the planar filter screen 20 and scrape debris off the screen as the scraper 24 rotates. The ridges 24b rotate and contact the screen 20 to scrape debris off the screen. The planar filter screen 20 prevents debris from entering the inlet ring 16 while the scraper 24 prevents debris from building up on the planar filter screen 20 and disrupting flow into the inlet ring 16. In embodiments, the space is provided between the planar screen 20 and the planar scraper 24 allows the scraper to deflect away from the screen in the event of a particularly large or stubborn piece of debris while continuing to rotate to preserver momentum. In embodiments, the ribs 24b are offset around the top surface of the circular scraper such that if one ridge is deflected by a large or stubborn piece of debris, the scraper continues to rotate and allows other ridges to contact the debris, which may either remove the debris or may deflect over it as well such that the scraper 24 will not stall or get stuck as long as water is flowing. Eventually repeated contact of the ridges 24b with even a larger piece of debris will dislodge the debris. In embodiments, the ridges 24b are angled relative to the axis of rotation of the scraper 24 to direct debris radially outward from the center to the scraper 24 and the planar screen 20 such that the screen remains clear.

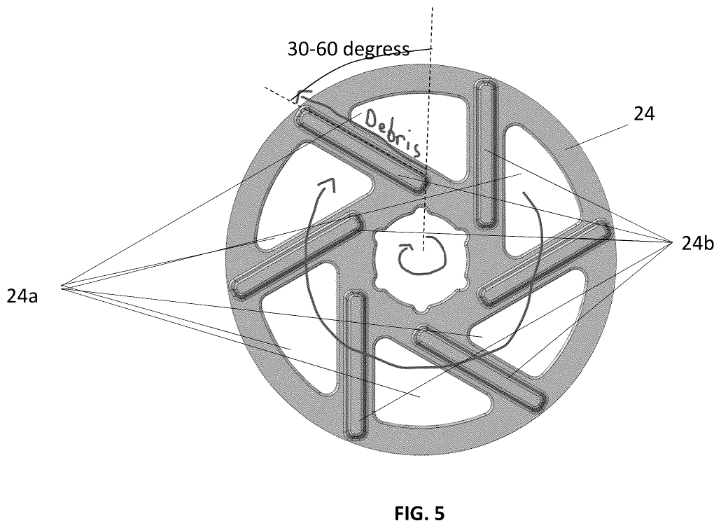

FIG. 5 illustrates a top view of the scraper 24 providing a more detailed view of the ridges 24b. As illustrated in FIG. 5, each of the ridges 24b is offset by an angle of 30-60 degrees relative to a radius of the substantially circular scraper 24. In embodiments, the orientation of the angle affects the direction in which the scraper 24 will rotate. The orientation of the ridges in FIG. 5 results in a clockwise rotation. In embodiments, the flow of water through the openings 24a interacts with the angled ridges 24b to rotate the scraper 24. As the scraper 24 rotates, debris is directed in the direction indicated in FIG. 5 and away from the screen 20. In embodiments, the ridges 24b are equally spaced and oriented.

In embodiments, a diaphragm securing element 30 interacts with the inlet ring 16 and the base 12 to secure the diaphragm element 10a in place. In embodiments, the diaphragm securing element 30 may be attached to the inlet ring 16 via threads 16c such that the diaphragm element 10a, is secured between the diaphragm securing element 30 and the base 12, which is held in place by the inlet ring 16. In embodiments, any suitable connection may be used. In embodiments, the inlet ring 16 is in fluid communication with the metering passage 32, which may extend upward from the diaphragm securing element 30 such that water passing through the ring 16, which has been filtered through screen 20 passes into the passage 32. In embodiments, a metering pin 34 (FIG. 4), or other metering element, may be mounted in the passage 32 to limit water flow in the passageway 32. In embodiments, the metering pin 34 may be moved in the passage 32 to alter the flow of water. In embodiments, the passage 32 is in fluid communication with the upper valve space 100b, above the diaphragm element 10a such that water passes into the upper valve space to maintain pressure and keep the seal 14 in contact with the valve seat 102 provided below the diaphragm element 10a to prevent the flow of water through the valve.

In embodiments, a spring 10b, or other biasing element is provided to bias the base 12 and the seal 14 downward to seal the valve seat 102 and keep the valve closed against the flow of water coming into the lower valve space 100a, which may be in fluid communication with an irrigation system pipe. In embodiments, the metering pin 34 may be adjusted using an adjustment element 104 provided at a top of the passage 32 to modify the flow of water moving through the passage 32 and into the upper valve space 100b.

In operation, water may flow in a pipe in which the valve 100 is mounted. In FIG. 4, the water is flowing in a direction into the page. In embodiments, where the valve 100 is in the closed position of FIG. 4, the valve remains closed to substantially block the flow of water. In embodiments, some water from the pipe passes through the openings 24a in the scraper 24 and then through the openings in the screen 20 into the inlet ring 16, where the filtered water passes through the openings 16a. In embodiments, as the water flows through the openings 24a, the scraper 24 rotates relative to the planar screen 20 and the ridges 24b on the top surface of the scraper remove any debris caught by the planar screen 20. The use of the planar filter screen 20 prevents debris from being carried into the inlet ring 16 and the activity of the scraper 24 prevents debris from building on the screen, which could also interrupt the flow of water into the metering passage 32. The combination of the planar screen 20 and the scraper 24 provide a reliable flow of debris-free water through the openings 16a of the inlet ring 16 and into the metering passage 32. The metering passage 32 is in fluid communication with the upper valve portion 100b. In embodiments, a metering pin 34 is mounted in the passage 32 to control the passage of water therethrough. In embodiments, the narrow spacing provided between the pin 34 and the walls of the passage 32 may limit the flow of water into the upper valve portion 100b. This tight spacing also makes it important that the water in the passage 32 is substantially free of debris which would clog the flow of water altogether. The measured flow of water into the upper valve portion 100b maintains water pressure to push the diaphragm element 10a, as well as the sealing surface 14 down against the valve seat 102 to keep the valve closed.

As is noted above, with respect to conventional valves, control signals may be provided to activate a solenoid, or other switching element to open a drain associated with upper valve portion 100b such that water passes out of the upper valve portion. In embodiments, the drop in water pressure in the upper valve portion 100b allows the pressure in the lower valve portion 100a to push the diaphragm element 10a upward and to move the sealing surface 14 away from the valve seat 102 once the bias of the spring 10b is overcome. Once the sealing surface 14 moves away from the valve seat 102, water flows over the seat 102 a direction into the page in FIG. 4, for example, where it may continue to flow to an outlet of the valve 100 and typically into another pipe in the irrigation system. In embodiments, the other pipe may be connected to a sprinkler element such that opening of the valve 100 activated the sprinkler element. In embodiments, the other pipe may be connected to multiple sprinkler elements, such that opening the valve 100 activated multiple sprinkler elements in an irrigation zone. In embodiments, the other pipe may be connected to another valve.

In embodiments, the valve 100 of the present disclosure prevents the passage of debris into the inlet ring 16 and further downstream into the metering passage 32 to reduce the chance of a clog in the metering passage or an inlet or exit thereof. Further, the inclusion of the scraper 24 provides for automatic cleaning of the planar screen 20 whenever water is flowing into the metering passage to prevent any blockage of the screen itself due to build up of debris. In embodiments, the face of the planar screen 20, and the face of the planar scraper 24 are positioned substantially parallel to the face of the inlet ring 16 such that water flow through all of them is in substantially the same direction such that debris protection and screen cleaning are provided without the need to redirect the flow of water in the valve 100 such that the benefits of the valve are provided while maintaining a normal flow path in the valve. As noted above, providing the scraper 24 upstream from the screen 20 ensures that the ridges 24b are pressed against the screen and the scraper is rotating any time water is flowing. The structure and positioning of the scraper 24 therefore ensures debris removal is active any time water is flowing, which is also when debris is most likely to be provided to the assembly 100. That is, one benefit of the scraper 24 is that it will rotate to clear the screen 20 regardless of the position of the diaphragm such that any time water flows, the scraper will be operating. Since the scraper 24 and screen 20 have a gap between them when water is not flowing, when the water is flowing, and the scraper is rotating, in the event that a particularly large or stubborn piece of debris is caught in the screen, the ridges 24b may deflect over the debris. As noted above, the ridges 24b are spaced apart from each other such that momentum is maintained when a large piece of debris results in deflection of one ridge 24b and continues to rotate such that the next ridge contact the debris.

In embodiments, speed control may be provided for the scraper 24. That is, in embodiments, the speed of rotation of the scraper 24 may be limited or otherwise controlled. In embodiments, a size of the gap between the scraper 24 and the screen 20 may be set to control the speed of rotation of the scraper 24. In embodiments, limiting a size of the gap, limits the flow of water through the scraper 24, which, in turn, limits the speed at which the scraper rotates. In embodiments, the shape of each of the protrusions 24b may be configured to provide speed control as well. In embodiments, the openings 24a may be formed in the scraper 24 such that the ribs 24c between the openings 24a are shaped to direct the flow of water toward the screen 20 and the protrusions 24b to provide for speed limiting. In embodiments, the combination of the shape of the ribs 24c, the shape of the protrusions 24b and the size of the gap between scraper 24 and the screen 20 may be used to control speed of the scraper.

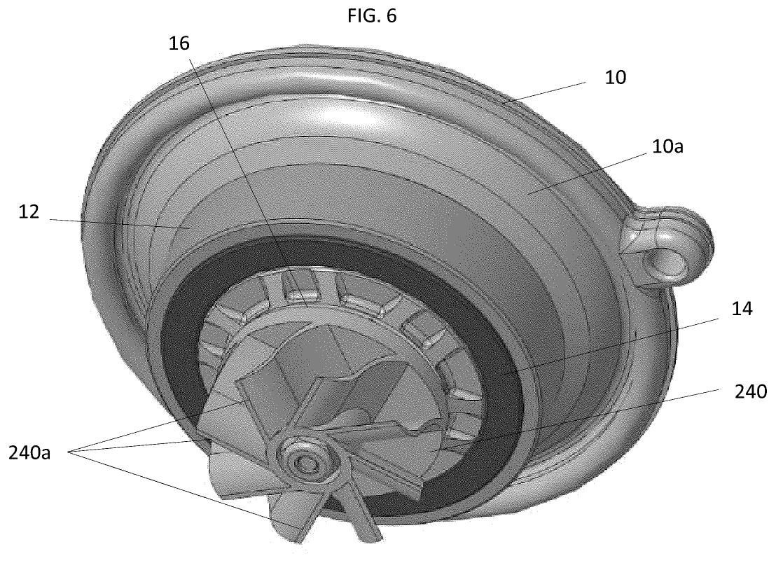

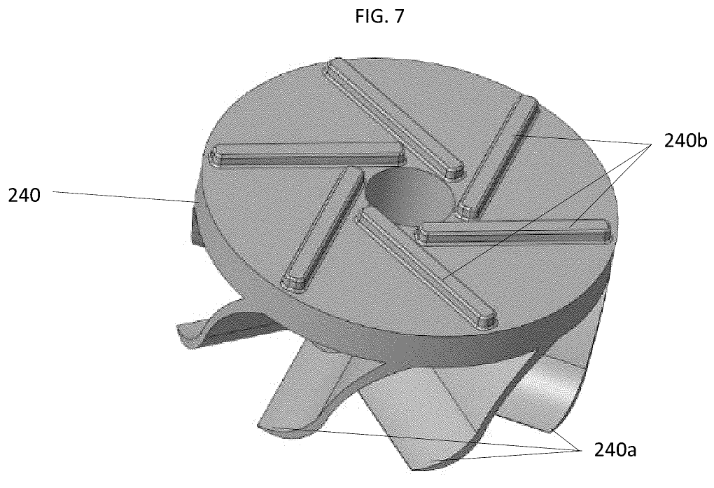

In embodiments, the diaphragm portion 10 of the valve 100 may include a scraper 240 that operates in substantially the manner described above with respect to scraper 24 as can be seen in FIG. 6. In embodiments, the scraper 240, however, includes one or more impeller blades 240a extending upstream from the bottom surface of the scraper 240. In embodiments, water flow drives the impeller blades 240a to rotate the scraper 240 when water flows through the valve 100. In embodiments, the scraper 240 includes ridges 240b (see FIG. 7) mounted on the upper surface of the scraper 240 similar to the ridges 24b discussed above that clear debris from the screen 20 as the scraper 240 rotates. In operation, water drives the impeller blades 240a to rotate the scraper 240 and around the edge of the scraper 240 and through the screen 20 and into the valve 100. In embodiments, prior to flow of water, the scraper 240 may be spaced from the screen 20 and is pushed against the screen 20 by the flow of water such that debris is removed from the screen 20 as the scraper 240 rotates.

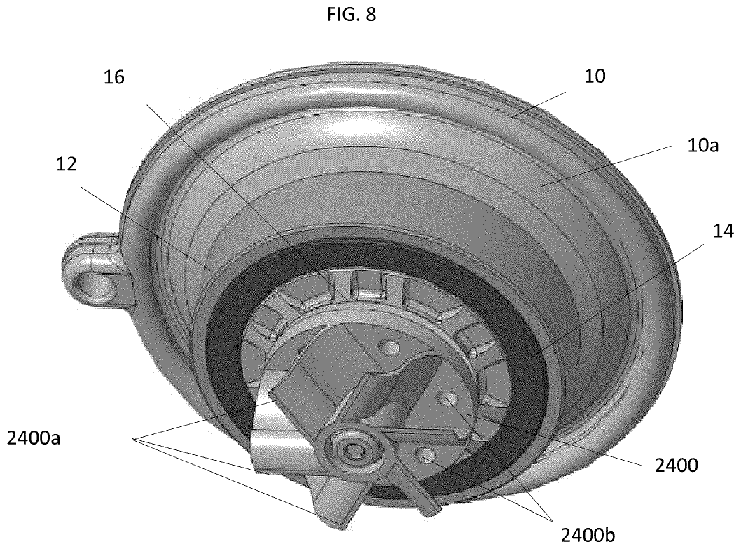

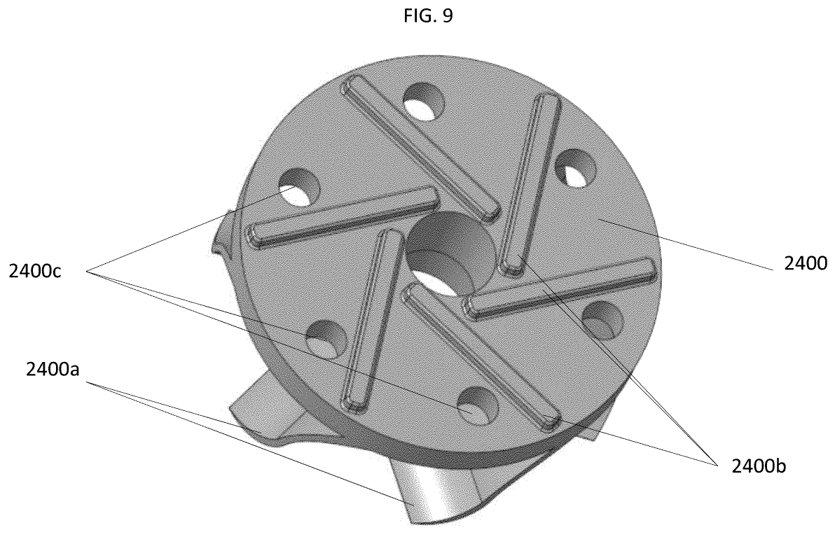

In embodiments, the diaphragm portion 10 of the valve 100 may include a scraper 2400 that operates in substantially the manner described above with respect to the scrapers 24 and 240 discussed above as can be seen in FIG. 8. In embodiments, the scraper 2400, however, includes one or more impeller blades 2400a extending upstream from the bottom surface of the scraper 2400. In embodiments, water flow drives the impeller blades 2400a to rotate the scraper 2400 when water flows through the valve 100. In embodiments, the scraper 2400 includes a circular base with a plurality of openings 2400c to allow water to pass through the base and the screen 20 and valve 100. In embodiments, ridges 2400b (see FIG. 9) mounted on the upper surface of the scraper 2400 similar to the ridges 24b and 240b discussed above, clear debris from the screen 20 as the scraper 2400 rotates. In operation, water drives the impeller blades 2400a to rotate the impeller 2400 and passes through the openings 2400c through the planar scraper 2400 and through the screen 20 and into the valve 100. In embodiments, prior to flow of water, the scraper 2400 may be spaced from the screen 20 and is pushed against the screen 20 by the flow of water such that debris is removed from the screen 20 as the scraper 2400 rotates.

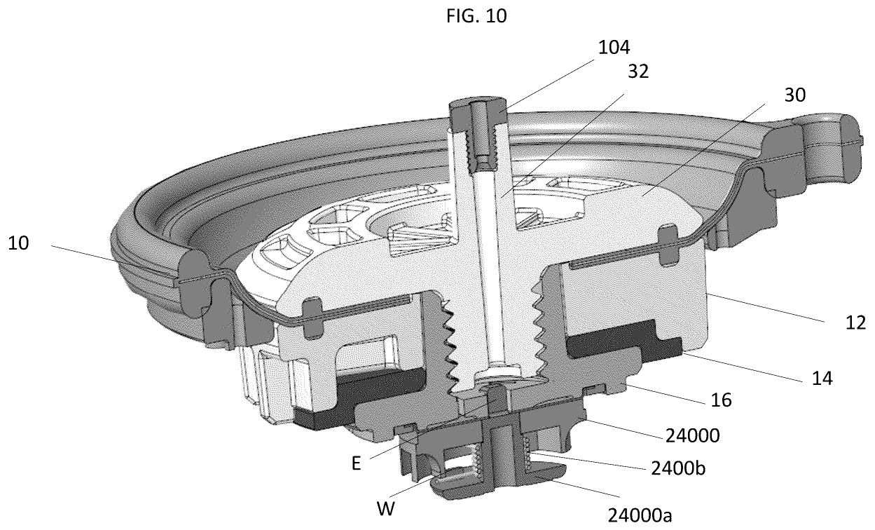

In embodiments, the diaphragm portion 10 of the valve 100 may include a scraper 24000 (see FIG. 10) that operates in a similar but somewhat different manner than the scrapers 24, 240, 2400. In embodiments, the scraper 24000 includes a plurality of curved fins 24000c extending upstream from the bottom surface of the scraper 24000 around a periphery thereof. The curved fins 24000c are positioned around the periphery of the upstream surface of the scraper 24000 such that the scraper 24000 rotates when water flows through the fins. A base 24000a is mounted in the upstream surface of the scraper 24000 and rotatably connects the scraper 24000 to the inlet 16 and the planar filter 20 such that the scraper may rotate relative to the base and the planar filter. A torsion spring 24000b is mounted on a central column of the base 24000a. One end of the torsion spring 24000b is secured to a wall W on the downstream surface of the downstream portion of the base 24000a. The opposite end of the torsions spring 24000b is secured by a curved wall 2400d formed in a middle portion of the upstream facing surface of the scraper 24000. The coil spring 2400b biases the scraper 24000 in place with the curved wall 2400d against the ramp wall RW on the scraper 24000. In embodiments, the base 24000a includes a square end E that is mounted in the inlet 16 such that the base does not rotate relative to the scraper 24000.

In operation, as water flows into the valve, the force of the water on the curved fins 24000c overcomes the bias of the spring 2400b and the scraper 24000 rotates relative to the base 24000a and the planar filter 20. Rotation is limited to 180 degrees by the circular peg P formed on the downstream surface of the lower portion of the base 24000a. A pair of opposed ridges 24000c extend from the downstream surface of the scraper 24000. In embodiments, as the scraper 24000 rotates, the ridges 24000e scrape the planar filter 20 to remove debris. When the water flow stops, the scraper 24000 returns to the biased position, and again removes debris from the planar filter 20 as it rotates back into position. In embodiments, the ridges 24000e are aligned with the flow of water to minimize loss of pressure as the water flows.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A flow control valve for an irrigation system comprises:
a valve seat in fluid communication with a water supply;
a base configured to selectively contact the valve seat to seal the valve seat;
a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat;
a top portion provided above the flexible diaphragm;
an inlet ring formed in the base and including at least one opening configured to allow water to flow therethrough and into the top portion, wherein water pressure above the diaphragm portion holds the base on the valve seat;
a metering passage provided downstream of the inlet ring and in fluid communication therewith to allow water into the top portion;
a metering pin adjustably mounted in the metering passage such that a position of the metering pin controls an amount of water that passes through the metering passage and into the top portion;
a planar filter provided upstream of the inlet ring and positioned such that water flows through the planar filter and into the inlet ring wherein the planar filter prevents debris from entering the inlet ring;
a scraper positioned upstream of the planar filter and rotatably mounted on the planar filter such that the scraper rotates as water flows through it and into the planar filter and removes debris from the planar filter.

2. The flow control valve of claim 1, wherein the base includes a seal portion provided on a bottom surface of the base and configured to provide a seal between the base and the valve seat.

3. The flow control valve of claim 1, further comprising a securing element configured to connect to the inlet ring such that the diaphragm portion and based are held in place between the securing element and the inlet ring.

4. The flow control valve of claim 1, wherein the securing element includes at least one thread that is configured to engage at least one corresponding thread of the inlet ring such that the diaphragm portion is secured in place between the inlet ring and based and the securing portion.

5. The flow control valve of claim 1, wherein the inlet ring includes a plurality of openings to allow water flow through the inlet ring.

6. The flow control valve of claim 1, wherein the scraper is disk shaped and includes one or more openings through which water passes into the planar filter.

7. The flow control valve of claim 6, wherein the scraper includes at least one ridge extending upward from a top surface and facing the planar filter, wherein the at least one ridge contacts the planar filter when water is flowing and the scraper is rotating relative to the planar filter to remove debris from the planar filter.

8. The flow control valve of claim 6, wherein the scraper includes at least one impeller blade extending from a bottom surface thereof such that the flow of water rotates the scraper.

9. The flow control valve of claim 6, wherein the scraper includes a plurality of impeller blades extending from a bottom surface thereof such that the flow of water rotates the scraper.

10. The flow control valve of claim 6, wherein the scraper includes a plurality of ridges extending upward from a top surface and facing the planar filter, wherein the plurality of ridges contact the planar filter when water is flowing and the scraper is rotating relative to the planar filter to remove debris from the planar filter.

11. The flow control valve of claim 6, wherein the scraper includes a plurality of curved fins formed around a periphery of a bottom surface thereof such that the flow of water rotates the scraper.

12. The flow control valve of claim 11, wherein the planar scraper includes a base element rotatably connecting the planar scraper to the planar filter such that the scraper is rotatable relative to the base element and the planar filter.

13. The flow control valve of claim 12, wherein the base element includes a cylindrical central shaft with a square end that is received in the planar filter to prevent the base element from rotating relative to the planar filter.

14. The flow control valve of claim 13, wherein the base element includes a coil spring mounted on the central shaft to limit rotation of the scraper relative to the planar filter and the base element.

15. The flow control valve of claim 14, wherein one leg of the coil spring is in contact with a straight wall positioned inside the periphery of the lower surface of the scraper and a second leg is in contact with a wall extending upward from a top surface of a lower portion of the base element to bias the scraper into a first position.

16. The flow control valve of claim 15, wherein the top surface of the lower portion of the base element includes a cylindrical peg extending upward toward the planar filter and spaced from the wall to limit rotation of the scraper relative to the base element and the planar filter.

17. A flow control valve for an irrigation system comprises:
a valve seat in fluid communication with a water supply;
a base configured to selectively contact the valve seat to seal the valve seat;
a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat;
a top portion provided above the flexible diaphragm;
an inlet ring formed in the base and including at least one opening configured to allow water to flow therethrough and into the top portion, wherein water pressure above the diaphragm portion holds the base on the valve seat;
a metering passage provided downstream of the inlet ring and in fluid communication therewith to allow water into the top portion;
a metering pin adjustably mounted in the metering passage such that a position of the metering pin controls an amount of water that passes through the metering passage and into the top portion;
a planar filter provided upstream of the inlet ring and positioned such that water flows through the planar filter and into the inlet ring wherein the planar filter prevents debris from entering the inlet ring;
a scraper positioned upstream of the planar filter and rotatably mounted on the planar filter wherein the scraper includes at least one impeller blade extending from an upstream side thereof such that the flow of water rotates the scraper and removes debris from the planar filter.

18. The flow control valve of claim 17, wherein the scraper includes a plurality of impeller blades, wherein the plurality of impeller blades rotate the scraper when water flows.

19. The flow control valve of claim 17, wherein the scraper includes a disk shaped body, wherein the body includes a plurality of openings formed therethrough, wherein water flows through the openings and into the planar filter and valve.

20. The flow control valve of claim 17, wherein the scraper includes one or more ridges extending from the downstream side of the scraper to contact the planar filter when the scraper rotates.

21. A flow control valve for an irrigation system in accordance with another embodiment of the present disclosure comprises:
a valve seat in fluid communication with a water supply;
a base configured to selectively contact the valve seat to seal the valve seat;
a flexible diaphragm portion connected to the base, wherein the base is provided at a center of the flexible diaphragm and the diaphragm is configured to flex to move the base into contact with the valve seat to limit water flow through the valve seat and away from the valve seat to allow water to flow through the valve seat;
a top portion provided above the flexible diaphragm;
an inlet ring formed in the base and including at least one opening configured to allow water to flow therethrough and into the top portion,
wherein water pressure above the diaphragm portion holds the base on the valve seat;
a metering passage provided downstream of the inlet ring and in fluid communication therewith to allow water into the top portion;
a metering pin adjustably mounted in the metering passage such that a position of the metering pin controls an amount of water that passes through the metering passage and into the top portion;
a planar filter provided upstream of the inlet ring and positioned such that water flows through the planar filter and into the inlet ring wherein the planar filter prevents debris from entering the inlet ring;
a scraper element positioned upstream of the planar filter and including a plurality of curved fins positioned around a periphery of a bottom surface of the scraper element such that the scraper rotates as water flows through it and into the planar filter to remove debris from the planar filter.

22. The flow control element of claim 21 comprising a base element rotatably connecting the scraper to the planar filter such that the scraper is rotatable relative to the base element and the planar filter.

23. The flow control element of claim 22 wherein the base element includes a cylindrical central shaft with a square end that is received in the planar filter to prevent the base element from rotating relative to the planar filter.

24. The flow control element of claim 23, wherein the base element includes a coil spring mounted on the central shaft and in contact with the scraper to limit rotation of the scraper relative to the planar filter and the base element.

25. The flow control element of claim 24, wherein one leg of the coil spring is in contact with a straight wall extending inside the periphery of the bottom surface of the scraper and a second leg in contact with a wall extending upward from a top surface of a lower portion of the base element to bias the scraper into a first position such that the scraper returns to the first position when water stops flowing through the planar filter.

26. The flow control element of claim 25, wherein the top surface of the lower portion of the base element includes a cylindrical peg extending upward toward the planar filter and spaced from the wall to limit rotation of the scraper relative to the base element and the planar filter.
